(19) United States
(12) Patent Application Publication
(10) Pub. No.: US 2009/0088028 A1
(43) Pub. Date: Apr. 2, 2009

(54) POWER CONNECTORS WITH CONTACT-RETENTION FEATURES

(75) Inventors: Hung Viet Ngo, Harrisburg, PA (US); Timothy W. Houtz, Etters, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: FCI AMERICAS TECHNOLOGY, INC., Reno, NV (US)

(21) Appl. No.: 12/109,750

(22) Filed: Apr. 25, 2008

Related U.S. Application Data
(60) Provisional application No. 60/976,620, filed on Oct. 1, 2007.

(51) Int. Cl. H01R 33/00; H01R 11/32; H01R 11/22

(52) U.S. Cl. 439/682; 439/853; 439/856

(57) ABSTRACT

A power receptacle contact may include first and second contact beams that deflect independently of one another during mating of the power receptacle contact with a complementary blade contact. Each beam may extend from abutting respective body portions. The power receptacle contact may include a first clip that extends from the first contact beam. The first clip may define a blade receiving area between the first and second contact beams. A power connector may include a housing and a contact received in the housing. The contact may includes first and second protrusions that prevent the contact from moving in a first direction.

### CROSS REFERENCE TO RELATED APPLICATIONS

This application claims the benefit of U.S. Provisional Application No. 60/976,620 filed Oct. 1, 2007.

### BACKGROUND

Connectors used to transmit electrical power, such as alternating current (AC) power and/or direct current (DC) power, may include a power contact mounted within an electrically-insulative housing. In a typical application, the connector may be mounted to a substrate, such as a circuit board, and the connector may be may be configured to mate with a corresponding power cable assembly. Specifically, each power contact within the housing may include one or more male contact beams and/or female receptacles that mate with that of the opposite gender within the power cable assembly.

When mating and un-mating the cable assembly with the mounted connector, substantial forces may be exerted on the individual power contacts within the cable assembly and within the mounted connector. These forces may dislodge the power contacts from their position in the housing and/or power cable if they are not sufficiently retained.

The capacity and efficiency of power transmission through power contacts may be affected by the contact's shape, size, material, internal resistance, extent of physical contact with the mating contact, etc. A contact's power transmission performance may relate to the quality and extent of physical contact between complementary contacts. Deformation of power contacts (e.g., by the forces of mating and unmating the connector) that affect the quality and extent of physical contact may affect the contact's power transmission performance. Traditionally, improving a contact's power transmission capacity and physical contact stability has been met with increasingly larger, heavier connectors. Increases in size and conductive materials often drive increases in manufacturing costs.

### SUMMARY

The disclosed electrical connectors and contacts employ a novel structure for improved performance in power capacity and physical contact stability and still allowing for lower manufacturing costs. For example, the electrical contacts may be stamped-metal contacts that include first and second contact beams that deflect independently of one another during mating of the power receptacle contact with a complementary blade contact. Each beam may extend from abutting respective body portions. The power receptacle contact may include a first clip that extends from the first contact beam. The first clip may define a blade receiving area between the first and second contact beams. An edge of the first clip may abut the second contact beam. The edge of the first clip may overlap the second contact beam. The power receptacle contact may include a second clip that extends from the second contact beam. The second clip may define a blade receiving area between the first and second contact beams. The contact beams may each be part of respective contact halves that are substantially identical.

The contacts may include various retention features to provide stability when mating and un-mating. For example, a power connector may include a housing and a contact received in the housing. The contact may include a body portion and a contact beam that extends from the body portion. The body portion may be a planar body portion. The contact beam may extend from the body portion in a first direction.

The contact may include first and second protrusions. The first protrusion may prevent the contact from moving in the first direction relative to the housing. For example, the first protrusion may include a latch that extends from the contact body and engages the housing.

The second protrusion may prevent the contact from moving in a second direction relative to the housing. The second direction may be opposite the first direction. The second protrusion may include a tab that extends from the planar body portion and engages the housing.

The contact may include a plurality of fingers that extend from the body portion in the second direction. The tab may prevent the fingers from spreading when a force in the second direction is applied to the contact portion.

### BRIEF DESCRIPTION OF THE DRAWINGS

FIGS. 1 and 2 depict an example electrical connector in top rear perspective view with and without a shroud, respectively.

FIGS. 3 and 4 depict the area designated “A” in FIG. 1, without the shroud, and power contacts in top front perspective view and bottom rear perspective view, respectively.

FIG. 5 depicts the area designated “A” in FIG. 1, without the shroud, and power contacts in top rear perspective view and illustrates the electrical connector mounted on a substrate and receiving an example power contact.

FIGS. 6-10B depict example power contacts, in top rear perspective view.

FIGS. 11 and 12 depict example mating compatibilities of example power contacts.

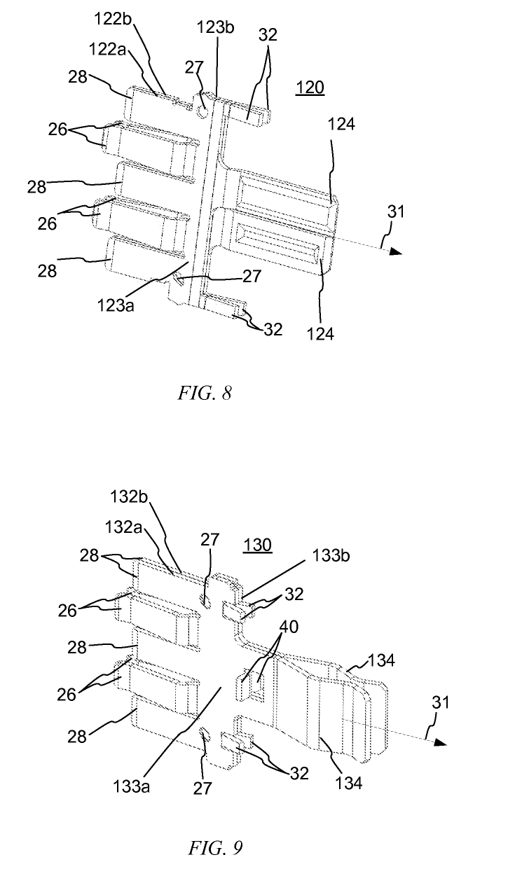

FIGS. 13 and 14 depict a cross-section through the line “B-B” of FIG. 1 in side view and in top rear perspective view, respectively, without the shroud.

FIG. 15 depicts a cross-sectional top view taken through the line “C-C” of FIG. 2.

FIG. 16 depicts a top rear perspective view of a portion of the area designated “A” in FIG. 1, without the shroud.

FIGS. 17 and 18 depict an example shroud in top front perspective view and top rear perspective view, respectively.

FIG. 19 depicts a rear view of the area designated “A” in FIG. 1.

FIG. 20 depicts a top view of a portion of the area designated “A” in FIG. 1, with the shroud of the connector installed on a housing of the connector in an incorrect orientation.

### DETAILED DESCRIPTION

Certain terminology may be used in the following description for convenience only and should not be considered as limiting in any way. For example, the terms “top,” “bottom,” “left,” “right,” “upper,” and “lower” designate directions in the figures to which reference is made. Likewise, the terms “inwardly,” “outwardly,” “upwardly,” and “downwardly” may designate directions toward and away from, respectively, the geometric center of the referenced object. The terminology includes the words above specifically mentioned, derivatives thereof, and words of similar import.

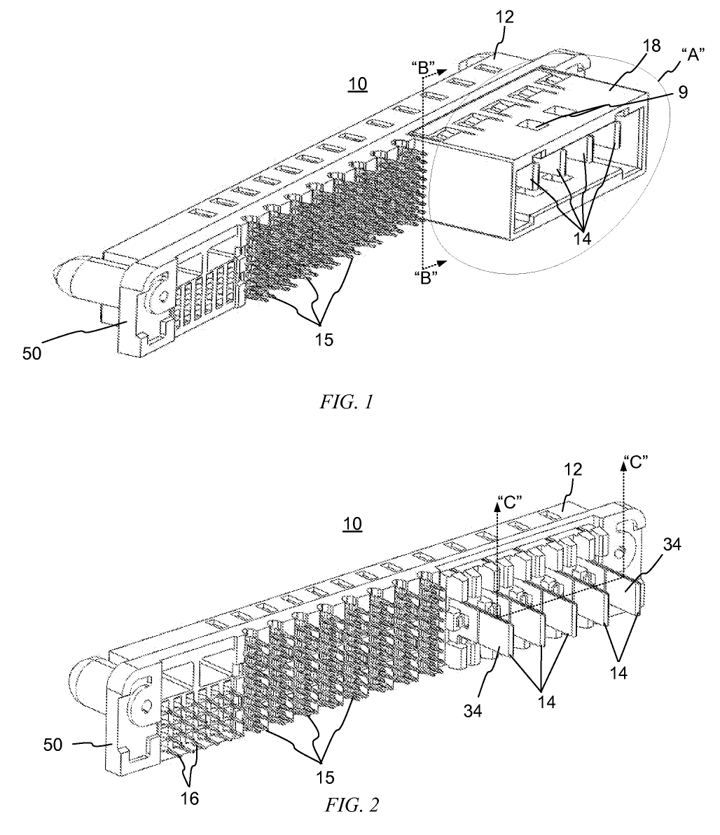

FIGS. 1 and 2 depict a top rear perspective view of connector 10, illustrated with a shroud 18 and without the shroud 18 respectively. The electrical connector 10 may provide electrical connectivity for data transmission signals and for power (i.e., alternating current (AC) power and direct current (DC) power).

The electrical connector 10 may include a housing 12, a power contact 14 for AC power, a power contact 15 for DC power, a signal contact 16 (shown in FIG. 2), and/or a shroud 18. The housing 12 may be an electrically-insulative housing. When the shroud 18 is retained to the housing 12, the shroud 18 may cover the power contacts 14.

The power contacts 14, 15 and signal contacts 16 may be mounted within the housing 12. As shown, connector 10 is depicted with five of the power contacts 14. The electrical connector 10 may include more or less than five of the power contacts 14 shown. Similarly, alternative embodiments can be configured with more or less than the number of power contacts 15 and signal contacts 16 than what is depicted.

The electrical connector 10 may be used in any application for which electrical conductivity between components is desired. For example, the electrical connector 10 may enable electrical conductivity between the power contacts 14 and a power cable assembly (not shown). The electrical connector 10 may enable electrical conductivity between the power contacts 14 and a complementary electrical connector (not shown). The electrical connector 10 may enable electrical conductivity between the power contacts 14 and a conductive trace on a substrate (not shown) to which the electrical connector 10 is mounted.

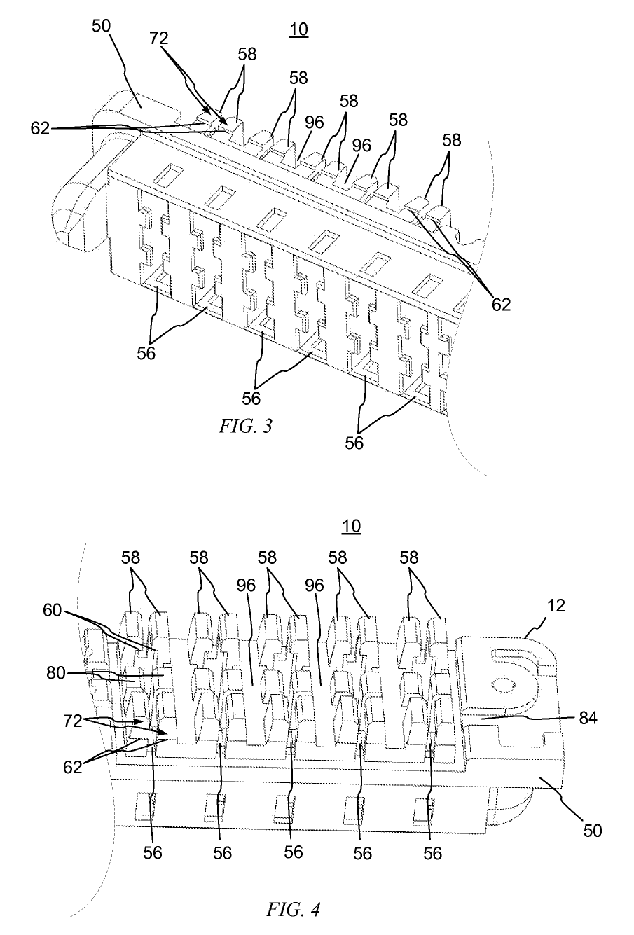

FIGS. 3-4 depict the area designated “A” in FIG. 1, without the shroud 18 and power contacts 14, in a top front perspective view and bottom rear perspective view, respectively. The housing 12 may define a middle portion 50. Adjacent columns of projections 58 may extend from the middle portion 50. Each projection 58 may define a respective horizontally-oriented lip 62 at the edge of an upwardly or downwardly-facing angled surface 72. The adjacent columns of projections 58 may define pockets 96 between the columns. The horizontally-oriented lips 62 and pockets 96 may be used to retain the shroud 18 to the connector housing 12.

The housing 12 may include one or more passages 56. The power contacts 14 may be retained within the passages. The passages 56 may extend through the housing 12 to enable connector mating on both sides of the housing 12.

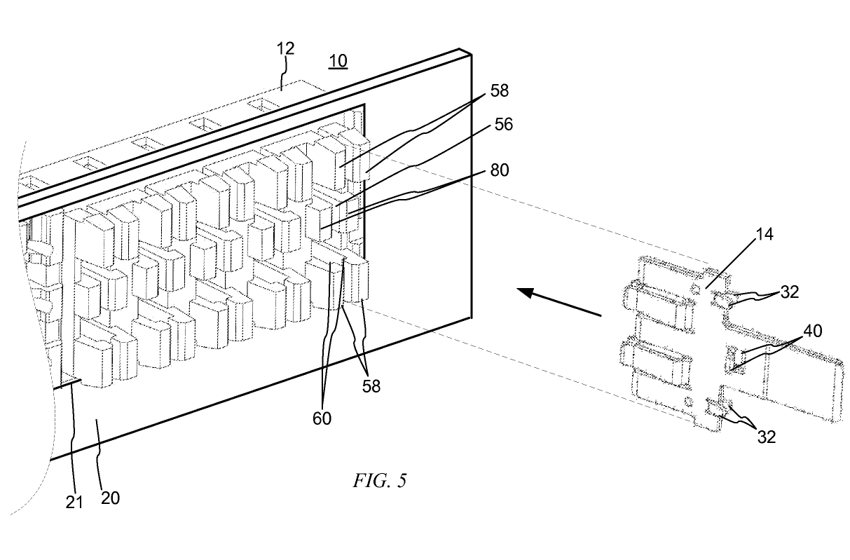

FIG. 5 depicts the area designated “A” in FIG. 1, without the shroud 18 and power contacts 14 in top rear perspective view and illustrates the electrical connector 10 mounted on a substrate 20 and receiving an example power contact 14. The connector 10 may be mounted on a substrate 20 such as a printed circuit board. The substrate 20 may include a cutout window 21 that permits the power contacts 14, 15 and the signal contacts 16 to pass through the substrate 20.

The housing 12 may include a retention feature to secure one or more power contacts 14. The projections 58 may help retain the power contacts 14 in the housing 12. In particular, the projections 58 each include a vertically-oriented lip 60 and a stop 80. Adjacent projections 58 may define a passage 56. The connector 10 may include one or more passages 56.

The power contact 14 may be received by the passage 56 as depicted in FIG. 5. Once the power contact 14 is inserted, the housing 12 in cooperation with the power contact 14 may secure the contact 14 within the passage 56. For example, the contact 14 may define one or more protrusions, such as latches 32 and tabs 40. The protrusions, in combination with features of the housing 12 may secure the power contact 14 within the passage 56. For example, the tab 40 may engage the stop 80 to prevent the contact 14 from moving further into the housing 12. For example, the latches 32 may engage the vertically-oriented lip 60 to prevent the contact 14 from moving back out of the housing 12, in a direction opposite the direction in which it was inserted.

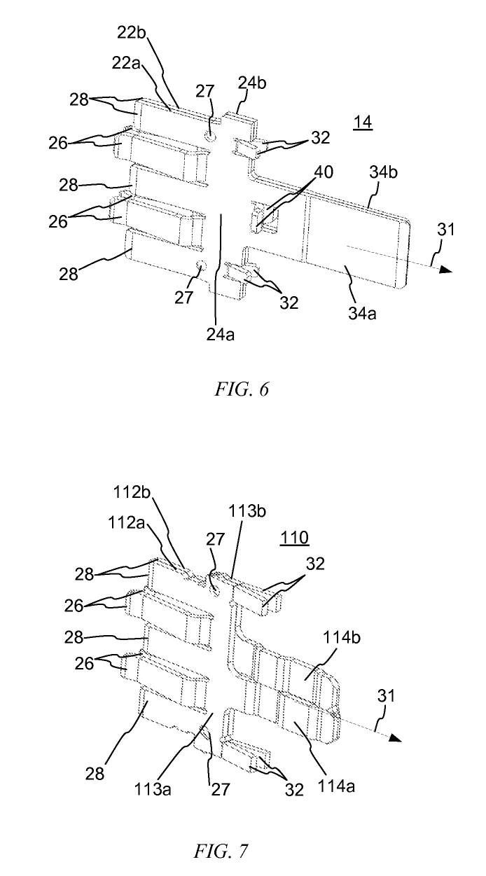

FIGS. 6-10B depict various example power contacts. The example power contacts may be manufactured using a common die with interchangeable tooling. For example, the power contacts may be manufactured as a stamped-metal contacts.

As depicted in FIG. 6, the power contact 14 may include a first half 22a and a substantially identical second half 22b. The first and second halves 22a, 22b may each include a body portion 24a, 24b. The body portions 24a, 24b may abut one another. The body portions 24a, 24b may be planar body portions. The first and second halves 22a, 22b may also include fingers extending from the body portion 24a, 24b. The fingers may include angled contact beams 26, and substantially straight contact beams 28. The angled contact beams 26 and the straight contact beams 28 may adjoin the body portion 24a, 24b of the corresponding first or second half 22a, 22b. The angled contact beams 26 and the straight contact beams 28 may be arranged on the body portions 24a, 24b in an alternating and/or staggered manner. The first half 22a may be stacked against a corresponding second half 22b, so that each angled contact beam 26 of the first half 22a faces a corresponding angled contact beam 26 of the second half 22b and each straight contact beam 28 of the first half 22a faces a corresponding straight contact beam 28 of the second half 22b.

The first and second halves 22a, 22b may each be configured with an alignment feature such as a projection 27. The projection 27 of each of the first and second halves 22a, 22b may be received in a corresponding through-hole formed in the other of the first or second halves 22a, 22b. Interference between the projection 27 and the peripheral surfaces of the corresponding through holes may maintain the first and second halves 22a, 22b in a state of alignment when, for example, the power contact 14 is inserted into the housing 12.

Contact beams 34a, 34b may each extend from respective first and second body portions 24a, 24b. A first contact beam 34a may extend from the first body portion 24a in a first direction 31. A second contact beam 34b may extend from the second body portion 24b in the first direction 31. Thus, each of the first and second halves 22a, 22b may each include a respective contact beam 34a, 34b that extends from the respective body portion 24a, 24b.

The contact beams 34a, 34b may be substantially flat. The contact beams 34a, 34b of each corresponding first half and second half 22a, 22b may face and abut each other. As shown in FIG. 6, the contact beams 34a, 34b may each be a male contact beam in the form of a contact blade. For example, the beams 34a, 34b may be faston blades. Other types of blades may be used as well.

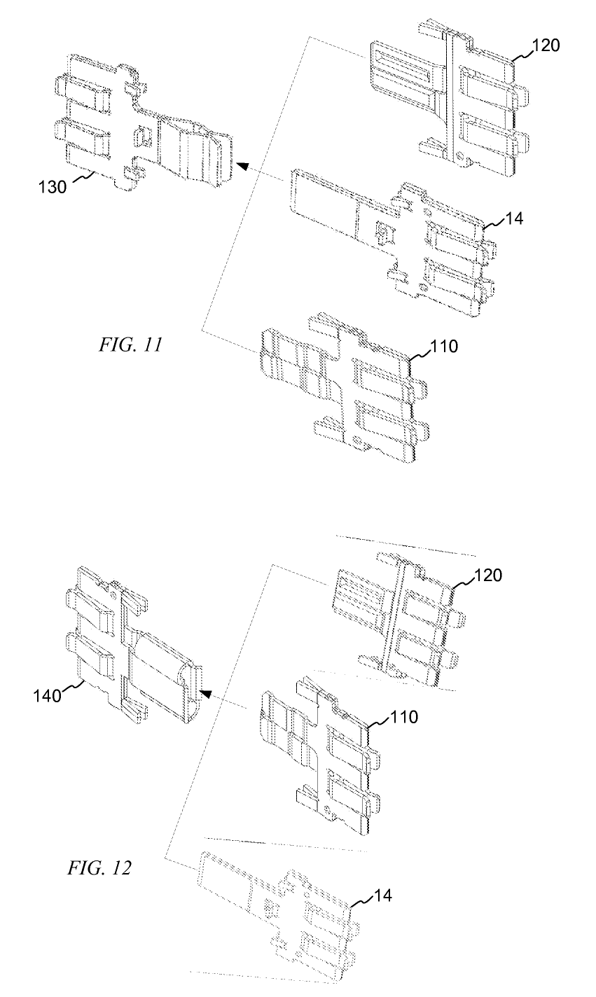

Each of the contact beams 34a, 34b may define an area 35 of reduced thickness (as shown in FIG. 15), to accommodate mating with a receptacle, such as a faston receptacle for example. In particular, the standard thickness of a male faston blade may be approximately 0.032 inch. The nominal thickness of the material from which the first and second halves 22a, 22b are formed may be approximately 0.020 inch. The reduced thickness area of each beam 34a, 34b may have a thickness of approximately 0.016 inch, so that the combined thickness of the reduced thickness areas 35 of the first and second halves 22a, 22b is approximately 0.032 inch.

The reduced-thickness areas 35 on each beam 34a, 34b may correspond to the portion of the beam 34a, 34b that contacts the faston receptacle. The outwardly-facing surfaces of the reduced thickness areas 35 may be substantially planar and may be substantially parallel to each other. Being substantially planar and substantially parallel may reduce the potential for an unbalanced or otherwise inadequate connection between the power contact 14 and the mating connector.

Each of the first and second halves 22a, 22b may include one or more protrusions to help secure the contact 14 within the housing 12. For example, the contact 14 may have a first protrusion that prevents the contact 14 from moving in a first direction 31 relative to the housing 12. The contact 14 may have a second protrusion that prevents the contact from moving relative to the housing 12 in a second direction that is opposite the first direction 31. The second direction may correspond to the direction in which the contact 14 is inserted into the housing 12.

The first protrusion may include a latch 32. The latch 32 may adjoin a respective body portion 24a, 24b of the corresponding first or second half 22a, 22b. The latch 32 may be angled in relation to the corresponding body portion 24a, 24b, as shown in FIG. 6. The latch 32 may extend generally outward from the corresponding body portion 24a, 24b. Two latches 32 may be used in combination, such that each latch 32 extends from a respective body portion 24a, 24b. Two sets of latches 32 may be used, such that each set of latches 32 is disposed on either side of the body portions 24a, 24b. The use of two sets of latches 32 is described for illustrative purposes only. Alternative embodiments can be configured with more, or less than two of the latches 32.

The second protrusion may be a tab 40. Each of the first and second halves 22a, 22b may include the tab 40. The tab 40 may be formed in the corresponding body portion 24a, 24b of the first or second half 22a, 22b. The tabs 40 may each extend in a direction substantially perpendicular to the major surface of the respective body portion 24a, 24b.

To illustrate, when the contact 14 is inserted into the housing 12, the tab 40 may prevent the contact 14 from moving further into the housing 12 and the latches 32 may engage the housing 12, preventing the contact 14 from moving back out of the housing 12. A third protrusion may be another latch 32, such that there are latches 32 at both sides of the body portion 24a, 24b with the tab 40 in between, relative to a direction perpendicular to the first direction 31.

The power contact 14 may be configured to receive corresponding contacts at each end. As shown, the power contact 14 may receive a first corresponding contact (not shown) at the contact beam 34a, 34b. Power contact 14 may received a second corresponding contact (not shown) at the fingers (e.g., angled contact beams 26 and substantially straight contact beams 28). For example, each pair of straight contact beams 28 may be received between a pair of angled contact beams of the second corresponding connector (not shown). Each pair of angled contact beams 26 of the connector 10 may receive a pair of straight contact beams of the second corresponding connector (not shown).

When the power contact is received in the housing 12, the tab 40 may prevent the insertion force of mating the first corresponding contact to deform the arrangement of the fingers. The insertion force of mating the first corresponding contact may tend to cause the fingers to spread apart and for the contact to bow. This deformation may cause less aligned mating between the fingers and the second corresponding contact, which may affect the contact's power transmission performance. The tab 40 may be disposed in-line with the direction of the insertion force. The tab 40 may be disposed substantially centered with respect to the fingers. The tab 40 may be disposed between the fingers and the contact beam 34a, 34b. The tab 40 may abut the housing and may tend to protect the alignment of the fingers for mating with the second corresponding contact in the presence of insertion force at the first corresponding contact. For example, the fingers may be substantially parallel to one another. The tab 40 may abut the housing under insertion force at the contact beam 34a, 34b such that the fingers remain substantially parallel to one another.

FIG. 7 depicts another power contact 110. Power contact 110 may have a first half 112a and a substantially identical second half 112b. The power contact 110 may have body portions 113a, 113b with contact beams 114a, 114b extending therefrom in a first direction 31 and with fingers (e.g., angled contact beams 26 and substantially straight contact beams 28) extending therefrom in a second direction that is opposite the first direction 31. The contact beams 114a, 114b may be configured as faston blades. The contact beams 114a, 114b may be offset from the centerline of the power contact 110 in the vertical direction, so that one of the contact beams 114 is positioned above the other contact beam 114 when the first and second halves 112a, 112b abut one another. The contact 110 may include one or more projections 27 for alignment. The contact 110 may include one or more latches 32 to help secure the contact 110 when received by a housing 12. Although not depicted in FIG. 7, a tab may be disposed in one or both of the first and second halves 112a, 112b, like tab 40 as shown in FIG. 6.

FIG. 8 depicts another power contact 120 having a first half 122a and a substantially identical second half 122b. The power contact 120 may have body portions 123a, 123b with contact beams 124a, 124b extending therefrom in a first direction 31 and with fingers (e.g., angled contact beams 26 and substantially straight contact beams 28) extending therefrom in a second direction that is opposite the first direction 31. The contact beams 124a, 124b may be configured as faston blades. The contact beams 124a, 124b may be offset from a centerline of the power contact 120, so that one of the contact beams 124b may be positioned above the other contact beam 124a when the first and second halves 122a, 122b abut one another. The contact 120 may include one or more projections 27 for alignment. The contact 120 may include one or more latches 32 to help secure the contact 120 when received by a housing 12. Although not depicted in FIG. 8, a tab may disposed in one or both of the first and second halves 122a, 122b, like tab 40 as shown in FIG. 6.

FIG. 9 depicts another a power contact 130 having a first half 132a and a substantially identical second half 132b. The power contact 130 may have body portions 133a, 133b with receptacle contact beams 134a, 134b extending therefrom in a first direction 31 and with fingers (e.g., angled contact beams 26 and substantially straight contact beams 28) extending therefrom in a second direction that is opposite the first direction 31. The receptacle contact beams 134a, 134b may face each other when the first and second halves 132a, 132b abut one another. The receptacle contact beams 134 receive the male contact beams of another connector, such as the connector of an AC power cord. The contact 130 may include one or more projections 27 for alignment. To help secure the contact 130 when received in a housing 12, the contact 130 may include one or more latches 32 and one or more tabs 40.

FIGS. 10A and 10B depict example receptacle power contacts 140, 141. The power contacts 140, 141 may be used in an electrical connector 10 and/or power cable assembly. For example, the power contact 140, 141 may be received in a housing, and electrically connected to a cable, such as an AC power cord.

Power contacts 140, 141 may have a first half 142a and a substantially identical second half 142b. The first and second halves 142a, 142b each include a respective body portion 143a, 143b that abut one another. A respective contact beam 144a, 144b may extend from each body portion 143a, 143b in a first direction 31. Each respective contact beam 144a, 144b may be offset from a centerline of the body portion 143a, 143b from which it extends. The contact beams 144a, 144b may face each other when the respective body portions 143a, 143b abut one another. The contact beams 144a, 144b may be substantially flat.

The power contact 140, 141 may include latches 32. Although not depicted in FIGS. 10A and 10B, a tab may disposed in one or both of the first and second halves 142a, 142b, like tab 40 as shown in FIG. 6. The latches 32 and tab 40 may be used to help secure the power contact 140, 141 when received in a housing 12.

The receptacle contact beams 144a, 144b may be configured to receive a male contact blade of a corresponding power contact. The contact surface of the contact beams 144a, 144b (e.g., the surface of the contact beams 144a, 144b that contacts the male contact blade of a corresponding electrical contact), may be offset from a vertical plane defined by a surface of the body portion 143a, 143b from which it extends. For example, the vertical plane may be defined as passing through the center of the power contact 140, 141. The offset may be approximately one-half of the thickness of a corresponding male contact blade. For example, the offset may be approximately 0.016 inch.

With regard to the first half 142a, a first clip 148a may extend from the first contact beam 144a. The clip 148a may define a blade receiving area between the first contact beam 144a and the second contact beam 144b. With regard to the second half 142b, a second clip 148b may extend from the contact beam 144b. The second clip 148b may define a blade receiving area between the first contact beam 144a and the second contact beam 144b. The clips 148a, 148b may be C-shaped, for example. As shown in FIG. 10A, an edge of the first clip 148a may abut the second contact beam 144b. Similarly, an edge of the second clip 148b may abut the first contact beam 144a. As shown in FIG. 10B, an edge of the first clip 148a may overlap the second contact beam 144b. Similarly, an edge of the second clip 148b may overlap the first contact beam 144a.

The arrangement of contact beam 144a, 144b and clip 148a, 148b may enable the contact beams 144a, 144b to deflect independently of each other, when mating (i.e., receiving a corresponding male contact beam in the defined blade receiving area). The receptacle contact beams 144a, 144b may deflect when mated with the corresponding male contact beams. The blade receiving area between each clip 148a, 148b and the corresponding contacting surface of the male contact blade may act as the initial point of deflection.

Independent deflection may result in independent loading of the receptacle contact beams 144a, 144b, which may help to ensure that the contact surfaces of the contact beams 144a, 144b remain substantially parallel to the contact surfaces of the corresponding male contact blade. The independent loading of the receptacle contact beams 144a, 144b also may help to ensure that the receptacle contact beams 144a, 144b and the male contact blade remain in a state of equilibrium once mated.

FIGS. 1 and 12 depict an example mating compatibility of the example power contacts. As shown in FIG. 1, contact 130 may mate with the contacts 14, 110, and 120, in applications where such mating is desired. As shown in FIG. 12, contact 140 may mate with the contacts 14, 110, and 120, in applications where such mating is desired. The contacts may be retained in an electrical connector housing. The electrical connector housing may be mounted to a substrate, such as a circuit board for example. The contacts may be electrically connected to a power cable as part of a power cable assembly.

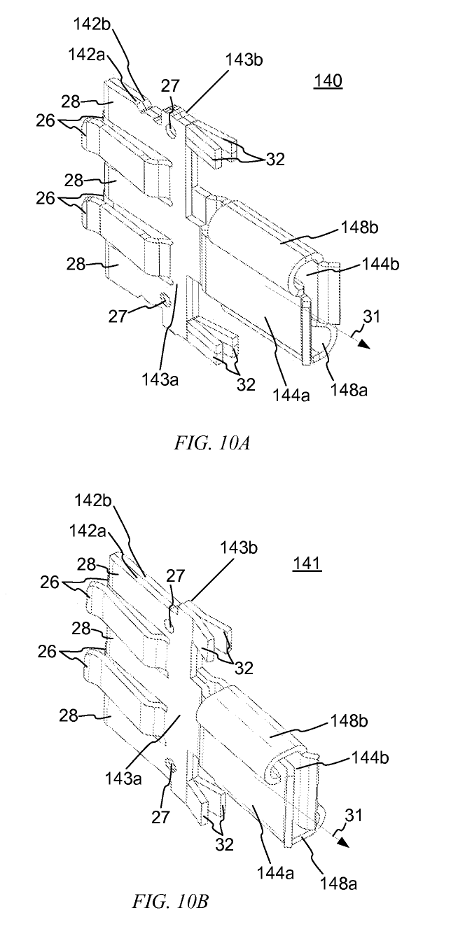

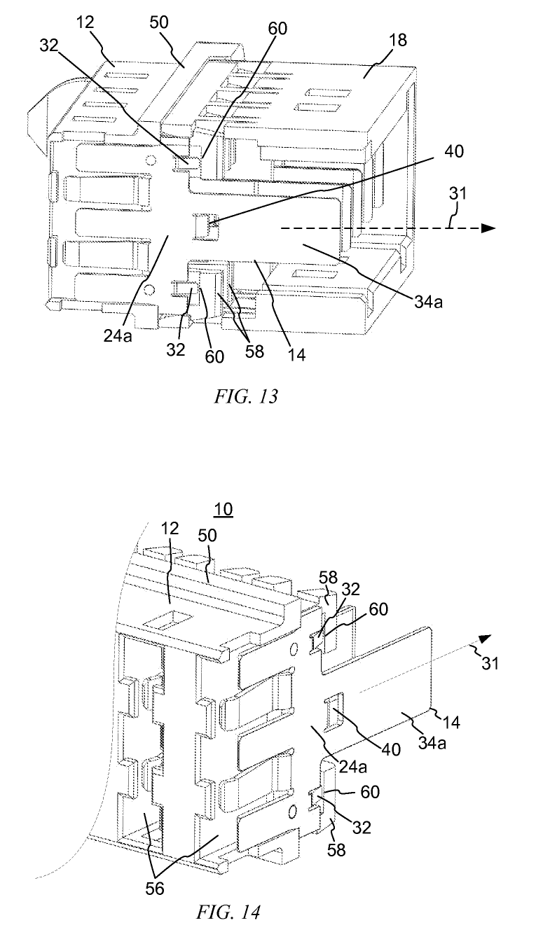

FIGS. 13-16 depict various views illustrating the example power contact 14 received in the housing 12. FIGS. 13-14 depict a cross-section through the line “B-B” of FIG. 1 in side view and in top rear perspective view, respectively, without the shroud 18. FIG. 15 depicts a cross-sectional top view taken through the line “C-C” of FIG. 2. FIG. 16 depicts a top rear perspective view of a portion of the area designated “A” in FIG. 1, without the shroud 18. The housing 12 may define a plurality of projections 58. Between the projections 58, the housing may define corresponding passages 56. The contact 14 may be inserted into the housing 12 and into a passage 56. Each power contact 14 may be retained in a corresponding passage 56. The projections 58 may help to retain the power contacts 14.

As shown in FIGS. 13 and 14, once the contact 14 is received by the passage 56, the projections 58 in cooperation with the latches 32 of the contact 14 may prevent the contact from moving in a first direction 31. The first direction 31 may be defined according to the direction in which the contact beam 34a, 34b extends from the contact body 24a, 24b. In particular, the projections 58 may each include a vertically-oriented lip 60 that abuts the latches 32 when the contact 14 is within the passage 56.

As the contact 14 is being inserted into the housing, the angled orientation of the latches 32 may cause the latches 32 to deflect inwardly as they contact the projections 58. The resilience of the latches 32 may cause each latch 32 to spring outwardly, toward its un-deflected position, as it clears the corresponding lip 60. In their un-deflected positions, the latches 32 may abut the corresponding lip 60, preventing the contact 14 from moving in the first direction 31. For example, the latches 32 in cooperation with the projections 58 may prevent the contact 14 from backing out of its corresponding passage 56 when, for example, a corresponding AC power cable assembly is demated from the electrical connector 10 (i.e., pulled away from the connector 10 in the first direction 31).

As shown in FIGS. 15 and 16, the housing 12 may includes a plurality of stops 80. The stops 80 may project from the rearward side of the middle portion 50. The stops 80 may be located between the upper and lower rows of the projections 58.

The contact 14 may be inserted into the housing 12. A stop 80 may correspond with a tab 40 on the power contact 14. The stop 80 may, in cooperation with the tab 40 of the contact 14, prevent the contact from moving in a second direction that is opposite the first direction 31.

As the contact 14 is inserted into the housing, interference between the tab 40 and the associated stop 80 may prevent movement of the power contact 14 further into the housing. The stops 80 and the projections 58, by providing retention for the contacts 14, may obviate the need for structure in addition the housing to retain the contacts 14.

The tab 40 may prevent the fingers (e.g., angled contact beams 26 and substantially straight contact beams 28) from spreading apart when a force in the second direction is applied to the contact 14, such as when a corresponding AC power cable assembly is pushed onto and mated to the electrical connector 10, for example.

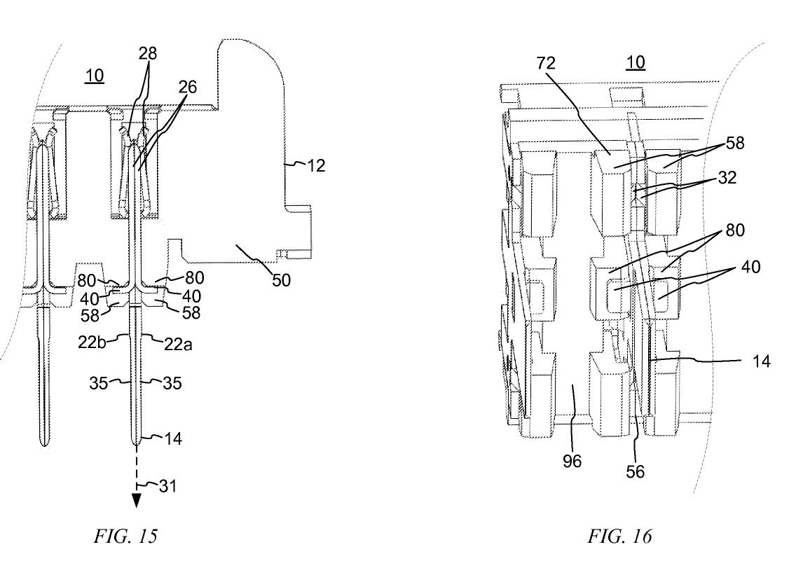

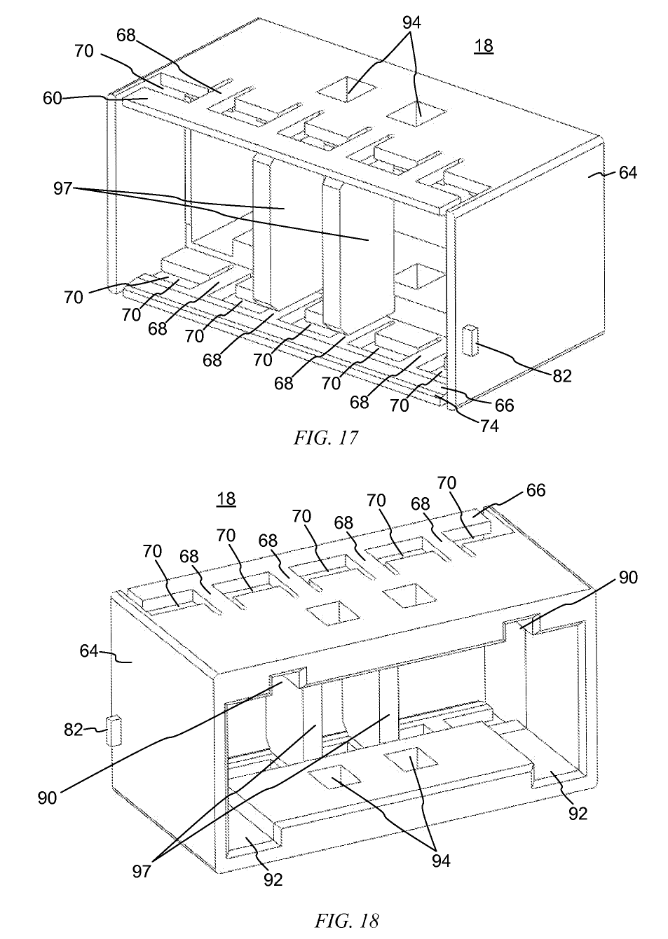

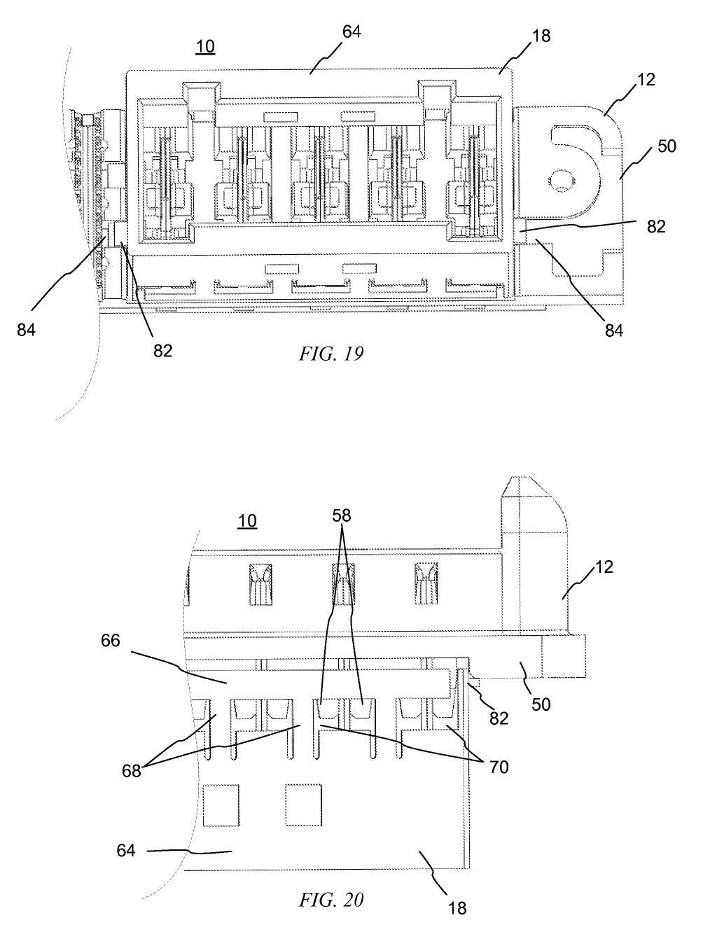

FIGS. 17 and 18 depict an example shroud 18 in top front perspective view and top rear perspective view, respectively. FIG. 19 depicts the shroud 18 retained by the housing 12, illustrating the area designated “A” in FIG. 1. FIG. 20 depicts the shroud 18 installed on the housing 12 in an incorrect orientation.

The shroud 18 may include a body 64 and two latch bars 66 that each may be connected to the body 64 by way of a plurality corresponding of latch arms 68. The body 64, latch bars 66, and latch arms 68 may define one or more openings 70.

The location of the opening 70 may correspond to the location of the projections 58 on the housing 12. As shown in FIGS. 3 and 4, the projections 58 may each include a horizontally-oriented lip 62 at the edge of an upwardly or downwardly-facing angled surface 72.

The shroud 18 may be retained to the housing 12 when an opening 70 receives a corresponding projection 58. When the shroud 18 is received by the housing 12 a ramp 74 of each latch bar 66 may engage the angled surfaces 72 of the corresponding projections 58. Contact between the angled surfaces 72 of the projections 58 and the ramps 74 may cause the latch bars 66 and the latch arms 68 to deflect, until the horizontally-oriented lips 62 at the edge if the angled surfaces 72 clear the latch bars 66. The resilience of the latch arms 68 may cause the latch bars 66 to move toward their un-deflected positions as the horizontally-oriented lips 62 become disposed within the corresponding openings 70. Once retained, the shroud 18 may be covered by a surfaces of a substrate when the connector 10 mounted to further helps to prevent the horizontally-oriented lips 62 from becoming disengaged from the latch bars 66.

While the shroud 18 is being mated to the housing 12, two partitions 97, defined within the body 64 of the shroud 18, may provide alignment. Each partition 97 may be received in a corresponding pocket 96 (i.e., the space defined between adjacent columns of projections 58 on the housing 12 as shown in FIG. 4). Contact between the partitions 97 and the sides of the projections 58 may help to align the shroud 18 with the housing 12 as the shroud 18 and the housing 12 are mated. Moreover, contact between the sides of the body 64 and the two outermost columns of projections 58 further may help to align the shroud 18 and the housing 12 during mating.

The shroud 18 and the housing 12 may include a polarization feature that helps prevent the shroud 18 from being installed incorrectly on the housing 12. In particular, the shroud 18 may include two projections 82. The projections 82 may be formed on opposite sides of the body 64 of the shroud 18. The projections 82 may be located below the center of the shroud 18 (i.e. the projections 82 may be located closer to the bottom of the shroud 18 than the top, as shown in FIGS. 17 and 18) The projections 82 may be located above the center of the shroud 18.

The middle portion 50 of the housing 12 may define two pockets 84 formed in the rearward-facing side thereof. Each pocket 84 may receive a corresponding projection 82 when the shroud 18 is installed correctly on the housing 12. The off-center location of the projections 82 may provide interference between the projections 82 and the middle portion 50 of the housing 12, when an attempt is made to install the shroud 18 incorrectly, e.g., upside down as shown in FIG. 20. This interference prevents the projections 58 of the housing 12 from engaging the latch bars 66 of the shroud 18.

The outermost projection 82, e.g., the projection 82 located on the right side of the housing 12, from the perspective of FIG. 19, may be trapped within the corresponding pocket 84 by a substrate when the connector 10 is mounted on the substrate. The outermost projection 82 thus may acts as a latch that further secures the shroud 18 on the housing 12.

The shroud 18 may include a polarization feature that helps prevent the power contacts 14 and a corresponding AC power cable from being mated incorrectly. In particular, the body 64 of the shroud 18 may define two slots 90 formed in a top portion thereof and may define two slots 92 formed in a bottom portion thereof.

The top slots 90 and the bottom slots 92 may be configured to receive relatively small diameter ribs and relatively large diameter ribs, respectively, on the connector of the AC power cable that mates with the connector 10. Accordingly, the top slots 90 may have a relatively small width, and the bottom slots 92 may have a relatively large width. The spacing between the top slots 90 may be different than that of the bottom slots 92. The noted differences in the spacing and widths of the slots 90, 92 may prevent the connector of the corresponding AC power cable from being installed incorrectly, i.e., upside down. Once the AC power cable is correctly oriented, latches on the connector of the AC power cable may be received in through-holes 94 defined by the body 64 of the shroud 18 to help retain the AC power cable to the shroud 18, and thus, the connector 10.

What is claimed:

1. A power receptacle contact, comprising:
first and second contact beams each extending from abutting respective body portions; and
a first clip extending from the first contact beam and defining a blade receiving area between the first and second contact beams.

2. The power receptacle contact of claim 1, wherein an edge of the first clip abuts the second contact beam.

3. The power receptacle contact of claim 1, wherein an edge of the first clip overlaps the second contact beam.

4. The power receptacle contact of claim 1, wherein the first and second contact beams deflect independently of one another during mating of the power receptacle contact with a complementary blade contact.

5. The power receptacle contact of claim 1, wherein the first and second contact beams are part of respective contact halves and wherein the contact half associated with the first contact beam is substantially identical to the contact half associated with the second contact beam.

6. The power receptacle contact of claim 1, wherein the first contact beam is offset from a center line of the body portion from which the first contact beam extends.

7. The power receptacle contact of claim 1, wherein the first contact beam is offset from a vertical plane defined by a surface of the body portion from which the first contact beam extends.

8. A power connector, comprising:
a housing;
a power receptacle contact received in the housing, wherein the power receptacle contact comprises first and second contact beams each extending from abutting respective body portions, and a first clip that extends from the first contact beam and defines a blade receiving area between the first and second contact beams; and
a cable electrically connected to the contact.

9. A power connector, comprising:
a housing; and
a contact received in the housing, wherein the contact comprises a planar body portion, a contact beam extending in a first direction from the body portion, a plurality of fingers extending in a second direction that is opposite the first direction, and first protrusion extending from the body portion and aligned with the contact beam, such that that the first protrusion abuts the housing when a force is applied to the contact beam in the second direction.

10. The power connector of claim 9, wherein the first protrusion prevents the fingers from spreading when the force is an insertion force associated with mating a corresponding contact with the contact beam.

11. The power connector of claim 9, wherein the fingers are substantially parallel and wherein the fingers remain substantially parallel after the force is applied to the contact beam in the second direction, wherein the force is an insertion force associated with mating a corresponding contact with the contact beam.

12. The power contact of claim 9, wherein the first protrusion is substantially centered relative to the fingers.

13. The power contact of claim 9, wherein the first protrusion extends orthogonally from the planar body portion.

14. The power contact of claim 9, further comprising a second protrusion that extends from the body portion and prevents the contact from moving in the first direction relative to the housing.

15. The power connector of claim 9, wherein the contact includes first and second substantially identical abutting halves.

16. The power connector of claim 9, further comprising a shroud received by the housing, wherein the shroud surrounds the contact beam.

17. The power connector of claim 16, wherein the shroud defines a bar that engages a projection of the housing.
